(19) United States
(12) Patent Application Publication
(10) Pub. No.: US 2025/0216308 A1
(43) Pub. Date: Jul. 3, 2025

(54) Methods, Systems, and Devices for Cartridge and Assays

(71) Applicant: IDEXX Laboratories, Inc., Westbrook, ME (US)

(72) Inventors: David Connolly, Eliot, ME (US); Richard Andrews, Gorham, ME (US); Jeremy Hammond, Standish, ME (US); Jason Karp, Portland, ME (US); Michael Moon, Scarborough, ME (US)

(73) Assignee: IDEXX Laboratories, Inc., Westbrook, ME (US)

(21) Appl. No.: 18/952,115

(22) Filed: Nov. 19, 2024

Related U.S. Application Data
(60) Provisional application No. 63/615,371, filed on Dec. 28, 2023.

(51) Int. Cl. G01N 15/01; B01L 3/00; G01N 15/14; G01N 15/1434; G06V 10/70; G06V 20/69

(52) U.S. Cl. CPC G01N 15/01; B01L 3/502715; G01N 15/1434; B01L 2200/04; B01L 2300/0654; B01L 2300/0816; G01N 2015/1486; G06V 10/70; G06V 20/693

(57) ABSTRACT

A cartridge for imaging a biological sample is disclosed. The cartridge includes a housing including: (i) a port and (ii) a recess for receiving the biological sample. The cartridge additionally includes a gasket surrounding at least a of portion the recess of the housing, wherein the gasket includes at least one wall defining a boundary of a reservoir, wherein the reservoir includes the recess, and wherein the reservoir is in fluid communication with the port. The cartridge further includes a sheet interfaced with the at least one wall of the gasket, wherein when the at least one wall is interfaced with the sheet, the reservoir is defined as an area between the at least one wall, the recess of the housing, and a surface of the sheet, and wherein the sheet is optically transparent.

### CROSS-REFERENCE TO RELATED APPLICATIONS

This application claims the benefit of co-pending U.S. Provisional Patent Application Ser. No. 63/615,371, filed Dec. 28, 2023, which is hereby incorporated by reference in its entirety.

### FIELD OF THE DISCLOSURE

The present disclosure involves devices and systems for imaging a biological sample, and methods for using and manufacturing the devices and systems thereof. Namely, devices, systems, and methods of the present disclosure involve a cartridge containing a biological sample for testing, such as digital imaging.

### BACKGROUND

Testing and imaging of biological samples can be conducted utilizing a variety of different systems and methods. For example, a cartridge, compatible with an imaging device, can provide one or more areas for containing and/or imaging a biological sample (e.g., in a reservoir).

### SUMMARY

In an example, a cartridge for imaging a biological sample is disclosed. The cartridge includes a housing including: (i) a port and (ii) a recess for receiving the biological sample. The cartridge additionally includes a gasket surrounding at least a portion of the recess of the housing, wherein the gasket includes at least one wall defining a boundary of a reservoir, wherein the reservoir includes the recess, and wherein the reservoir is in fluid communication with the port. The cartridge further includes a sheet interfaced with the at least one wall of the gasket, wherein when the at least one wall is interfaced with the sheet, the reservoir is defined as an area between the at least one wall, the recess of the housing, and a surface of the sheet, and wherein the sheet is optically transparent.

In another example, a method of imaging a biological sample is disclosed. The method includes depositing a biological sample into a cartridge comprising a reservoir for receiving the biological sample, wherein the reservoir comprises an area having boundaries defined at least by: (i) a recess of a housing, (ii) at least one wall of a gasket, the gasket surrounding at least a portion of the recess, and (iii) a sheet interfaced with the at least one wall of the gasket. The method additionally includes inserting the cartridge into an imaging device. The method further includes capturing one or more images of the biological sample from an imaging sensor of the imaging device.

In another example, a method for manufacturing a cartridge for imaging a biological sample is disclosed. The method includes fabricating a housing including (i) a port and (ii) a recess for receiving a biological sample. The method additionally includes surrounding the recess with a gasket, wherein the gasket includes at least one wall defining a boundary of a reservoir, wherein the reservoir includes the recess, and wherein the reservoir is in fluid communication with the port. The method further includes disposing a sheet onto the at least one wall of the gasket, wherein when the at least one wall is interfaced with the sheet, the reservoir is defined as an area between the at least one wall, the recess of the housing, and a surface of the sheet, and wherein the sheet is optically transparent.

In another example, a method for imaging a biological sample by an imaging device is disclosed. The method includes receiving a cartridge comprising a biological sample, wherein the cartridge includes a reservoir containing the biological sample, wherein the reservoir includes an area having boundaries defined at least by: (i) a recess of a housing, (ii) at least one wall of a gasket, the gasket surrounding at least a portion of the recess, and (iii) a sheet interfaced with the at least one wall of the gasket. The method additionally includes capturing one or more images of the biological sample from an imaging sensor. The method further includes inputting the one or more images into one or more machine learning models. The method also includes identifying, via the one or more machine learning models, one or more characteristics of the biological sample in the one or more images. The method additionally includes transmitting instructions that cause a graphical user interface to display the one or more characteristics of the biological sample in the one or more images.

In another example method of calibrating an imaging device is disclosed. The method includes capturing one or more images of a cartridge, the cartridge comprising at least one target, and the one or more images capturing at least a portion of the at least one target. The method additionally includes inputting the one or more images of the at least one target into one or more computing models. The method further includes identifying, via the one or more computing models, one or more characteristics of the imaging device based on the targets. The method additionally includes transmitting instructions that cause an adjustment of a parameter of the imaging device based on the identified characteristic.

The features, functions, and advantages that have been discussed can be achieved independently in various examples or may be combined in yet other examples. Further details of the examples can be seen with reference to the following description and drawings.

### BRIEF DESCRIPTION OF THE FIGURES

The above, as well as additional features will be better understood through the following illustrative and non-limiting detailed description of example embodiments, with reference to the appended drawings.

FIG. 1 illustrates a simplified block diagram of an example computing device, according to an example embodiment.

FIG. 2A illustrates an example cartridge, before assembly of the cartridge, according to an example embodiment.

FIG. 2B illustrates the example cartridge of FIG. 2A during assembly, according to an example embodiment.

FIG. 2C illustrates an example cartridge, before assembly of the cartridge, according to an example embodiment.

FIG. 2D illustrates the example cartridge of FIG. 2C after assembly, according to an example embodiment.

FIG. 2E illustrates a cross-sectional view of the example cartridge of FIGS. 2C-2D after assembly, according to an example embodiment.

FIG. 3A illustrates an example cartridge, before assembly of the cartridge, according to an example embodiment.

FIG. 3B illustrates the example cartridge of FIG. 3A during assembly, according to an example embodiment.

FIG. 3C illustrates a cross-sectional view of the example cartridge of FIGS. 3A-3B after assembly, according to an example embodiment.

FIG. 4 illustrates a computing system configured for use with an imaging device and a mobile computing device, according to an example embodiment.

FIG. 5 illustrates an example cartridge for calibrating an imaging device, according to an example embodiment.

FIG. 6 illustrates a method, according to an example embodiment.

FIG. 7 illustrates a method, according to an example embodiment.

FIG. 8 illustrates a method, according to an example embodiment.

FIG. 9 illustrates a method, according to an example embodiment.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

Within examples, the present disclosure is directed to devices and systems for imaging and/or otherwise analyzing a biological sample, and methods for manufacturing the devices and systems thereof.

Testing and/or imaging, as referred to herein, may include, for example, capturing one or more images related to a sample. For example, testing can involve capturing images of a biological sample from an imaging sensor and determining one or more parameters of the biological sample and/or components thereof. One or more machine learning models can then be implemented to analyze the captured images and perform one or more computational actions, including identifying a characteristic of the biological sample. In some examples, computer vision techniques can also be employed to identify and process characteristics of a biological sample in an image.

In another example, if the one or more images come from competitive immunoassays for detection of antibodies in the biological sample, then a competitive immunoassay may be carried out in the following illustrative manner. A sample (e.g., from an animal's body fluid) potentially containing an antibody of interest that is specific for an antigen, is contacted with the antigen attached to the particle and with the anti-antigen antibody conjugated to a detectable label. In some examples, the antibody of interest, present in the sample, competes with the antibody conjugated to a detectable label for binding with the antigen attached to the particles. The amount of the label associated with the particles can then be determined after separating unbound antibody and the label. In this example, the signal obtained is inversely related to the amount of antibody of interest present in the sample.

In an alternative example embodiment of a competitive immunoassay, a sample, (e.g., from an animal's body fluid), potentially containing an analyte, is contacted with the analyte conjugated to a detectable label and with an anti-analyte antibody attached to the particle. In examples, the antigen in the sample competes with an analyte conjugated to the label for binding to the antibody attached the particle. The amount of the label associated with the particles can then be determined after separating the unbound antigen and label. In this example, the signal obtained is inversely related to the amount of analyte present in the sample.

In a further aspect, antibodies, antigens, and other binding members (e.g., aptamers) may be attached to the particle or to the label directly via covalent binding with or without a linker or may be attached through a separate pair of binding members as is well known (e.g., biotin: streptavidin, digoxigenin: anti-digoxiginen). In addition, while the examples herein reflect the use of immunoassays, the particles and methods of the disclosure may be used in other receptor binding assays, including nucleic acid hybridization assays, that rely on immobilization of one or more assay components to a solid phase.

Generally, devices and systems for imaging a biological sample described herein include a cartridge with a reservoir for containing a biological sample. In example embodiments, different heights and volumes of a reservoir can have advantages depending on the type of biological sample being tested, the concentration of cells within a biological sample, and/or the type of testing performed. For instance, the concentration of cells and/or dilution factor of the biological sample can be matched with an appropriate height of the reservoir to optimize settling time (e.g., 1 micron per second for blood cells). The settling time of a biological sample can be longer or shorter depending on the specific gravity of the diluent and size and/or density of the cells. In example implementations, if one or more components of the biological sample (e.g., cells of interest) have a low concentration, a higher reservoir height can be more beneficial as a user can wait for those one or more components (e.g., cells) to settle. Once the one or more components (e.g., cells) have settled, the settled one or more components (e.g., cells) may have a higher concentration at one or more locations within the reservoir, for example, on or near the bottom of the reservoir. When imaging the biological sample, this arrangement and protocol can improve imaging and/or other diagnostics by, for example, requiring fewer fields of view in to achieve a desired number of one or more components (e.g., cells) present in an image.

In another example, for imaging fluid samples (e.g., blood), a shallow reservoir having a smaller reservoir height and volume can be more beneficial to help facilitate dispersing the biological sample into a thinner, more even layer and prevent any air pockets. As such, imaging of a fluid sample may be more uniform which can improve consistency, accuracy, and repeatability of tests. Alternatively, in examples where the biological sample includes a solid sample (e.g., ear wax, fecal matter), it may be more beneficial to have a higher reservoir height, and thus a greater reservoir height and volume, to allow sufficient space for the sample to be imaged and/or mix with one or more liquids (e.g., a diluent and/or stain), among other possibilities.

An example cartridge, according to devices and systems disclosed herein, includes: (i) a housing; (ii) a gasket, and (iii) a sheet. Together, the housing, the gasket, and the sheet define boundaries of a reservoir which contains the biological sample during testing. In example configurations disclosed herein, the gasket is positioned between the housing and the sheet, creating a gap and/or area between the housing and the sheet. As such, a variation in the size of the gasket creates a variation in the gap and/or area height between the housing and the sheet. For instance, a larger gasket will create a larger gap and/or area height between the housing sheet and a smaller gasket will create a smaller gap and/or area height between the housing and the sheet. Consequently, assuming the reservoir and sheet dimensions do not change, a larger gasket will create a larger volume of the reservoir and a smaller gasket will create a smaller volume of the reservoir.

During assembly of the cartridge, the gasket may be disposed in a predefined channel of the housing so that the gasket is positioned between the housing and the sheet during assembly. In examples, the sheet can then be interfaced with and/or coupled to the housing, for instance, via fasteners. Methods of assembly of the cartridge disclosed herein allow for a variety of sizes of gaskets to be utilized with the same or similar housing and with the same or similar sheet. By utilizing the same or similar components to assemble cartridges that can be used in a variety of use cases, assembly automation and reduced production time and cost may be realized. The example cartridges and methods described herein also improve precision and consistency of one or more parameters of the cartridge, including reservoir heights and dimensions, where other cartridge designs have more part-to-part variation. These improvements may lead to improved imaging techniques and diagnostic results (e.g., assay results), alike.

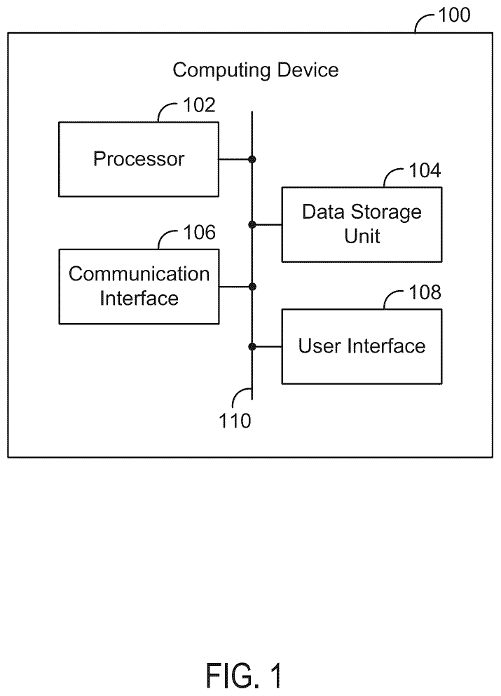

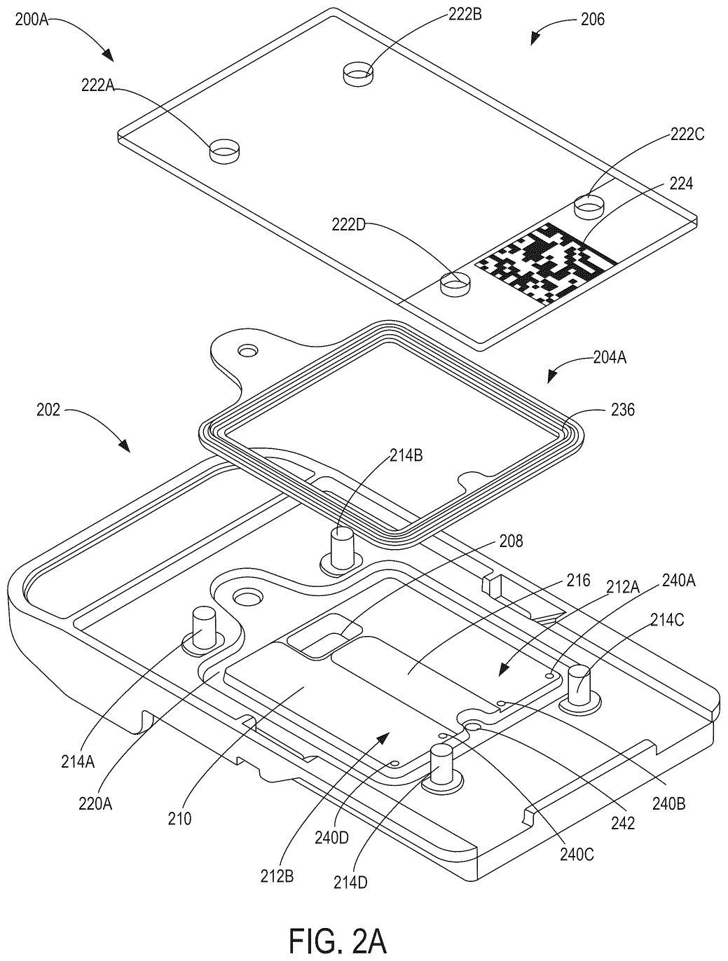

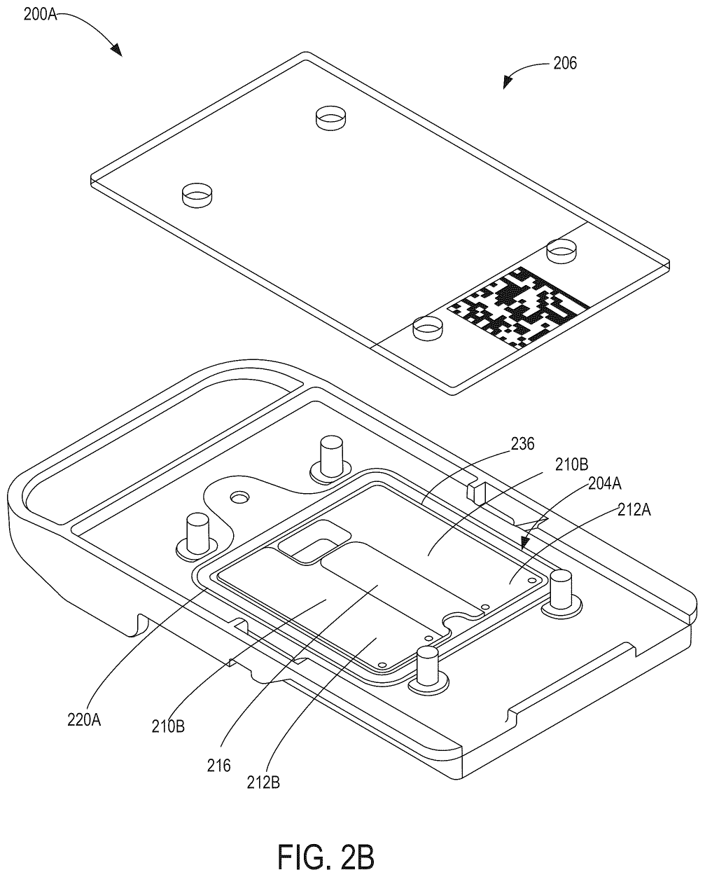

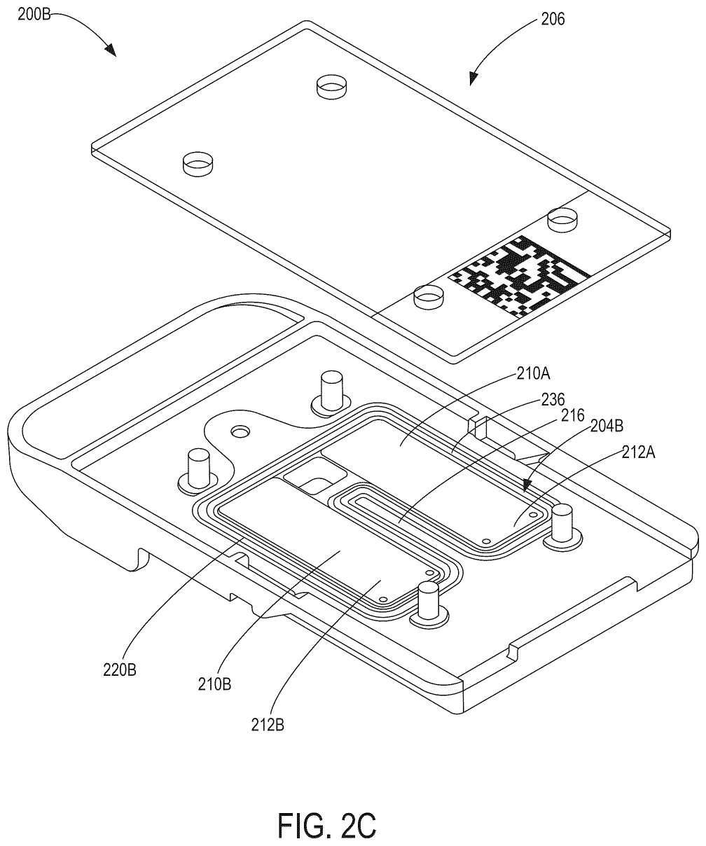

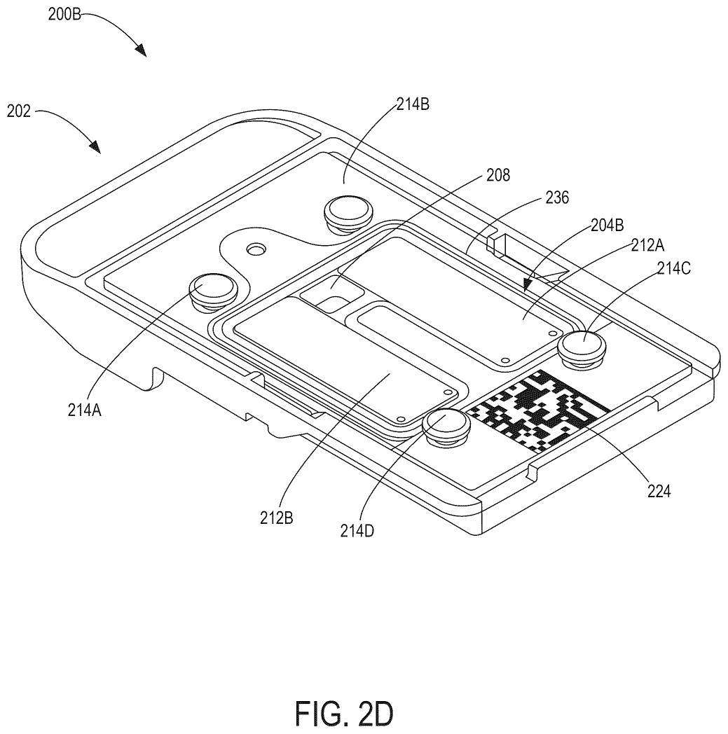

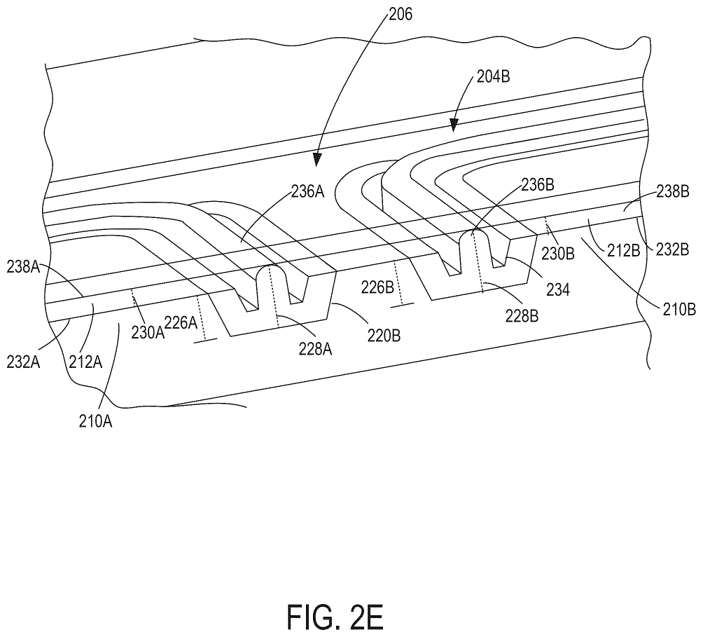

Referring now to the figures, FIG. 1 is a simplified block diagram of an example computing device 100 of a system (e.g., that can be utilized with devices and methods illustrated in FIGS. 2A-4, described in further detail below). Computing device 100 can perform various acts and/or functions, such as those described in this disclosure. Computing device 100 can include various components, such as processor 102, data storage unit 104, communication interface 106, and/or user interface 108. These components can be connected to each other (or to another device, system, or other entity) via connection mechanism 110.

Processor 102 can include a general-purpose processor (e.g., a microprocessor and/or a central processing unit (CPU)) and/or a special-purpose processor (e.g., a digital signal processor (DSP) and/or a graphics processing unit (GPU)).

Data storage unit 104 can include one or more volatile, non-volatile, removable, and/or non-removable storage components, such as magnetic, optical, or flash storage, and/or can be integrated in whole or in part with processor 102. Further, data storage unit 104 can take the form of a non-transitory computer-readable storage medium, having stored thereon program instructions (e.g., compiled or non-compiled program logic and/or machine code) that, when executed by processor 102, cause computing device 100 to perform one or more acts and/or functions, such as those described in this disclosure. As such, computing device 100 can be configured to perform one or more acts and/or functions, such as those described in this disclosure. Such program instructions can define and/or be part of a discrete software application. In some instances, computing device 100 can execute program instructions in response to receiving an input, such as from communication interface 106 and/or user interface 108. Data storage unit 104 can also store other types of data, such as those types described in this disclosure.

Communication interface 106 can allow computing device 100 to connect to and/or communicate with another other entity according to one or more protocols. In one example, communication interface 106 can be a wired interface, such as an Ethernet interface or a high-definition serial-digital-interface (HD-SDI). In another example, communication interface 106 can be a wireless interface, such as a cellular or WI FI interface. In this disclosure, a connection can be a direct connection or an indirect connection, the latter being a connection that passes through and/or traverses one or more entities, such as a router, switcher, or other network device. Likewise, in this disclosure, a transmission can be a direct transmission or an indirect transmission.

User interface 108 can facilitate interaction between computing device 100 and a user of computing device 100, if applicable. As such, user interface 108 can include input components such as a keyboard, a keypad, a mouse, a touch sensitive panel, a microphone, a camera, and/or a movement sensor, all of which can be used to obtain data indicative of an environment of computing device 100, and/or output components such as a display device (which, for example, can be combined with a touch sensitive panel), a sound speaker, and/or a haptic feedback system. More generally, user interface 108 can include hardware and/or software components that facilitate interaction between computing device 100 and the user of the computing device 100.

Computing device 100 can take various forms, such as a workstation terminal, a desktop computer, a laptop, a tablet, a mobile phone, or a controller.

Referring now to FIGS. 2A-2E which illustrate example cartridges (i.e., cartridge 200A and cartridge 200B) at various stages in a manufacturing process. An example cartridge includes a housing, a gasket, and a sheet. Once the example cartridge is assembled, components of the housing, the gasket, and the sheet form boundaries of a reservoir. The reservoir is configured to contain a biological sample during testing.

Now referring specifically to FIG. 2A, which illustrates a housing 202, a gasket 204A, and a sheet 206, before assembly of the cartridge 200A, according to an example embodiment.

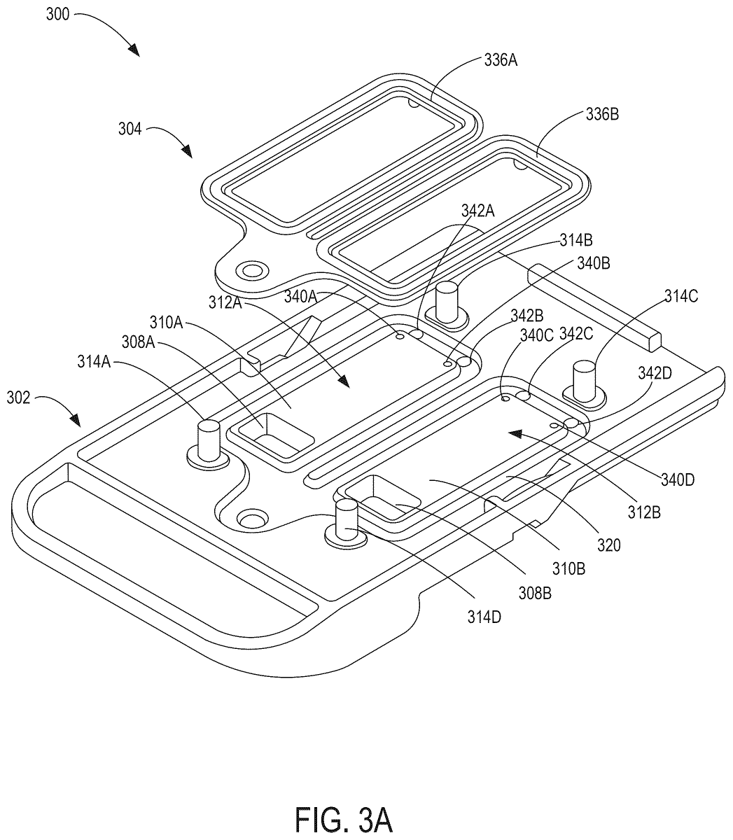

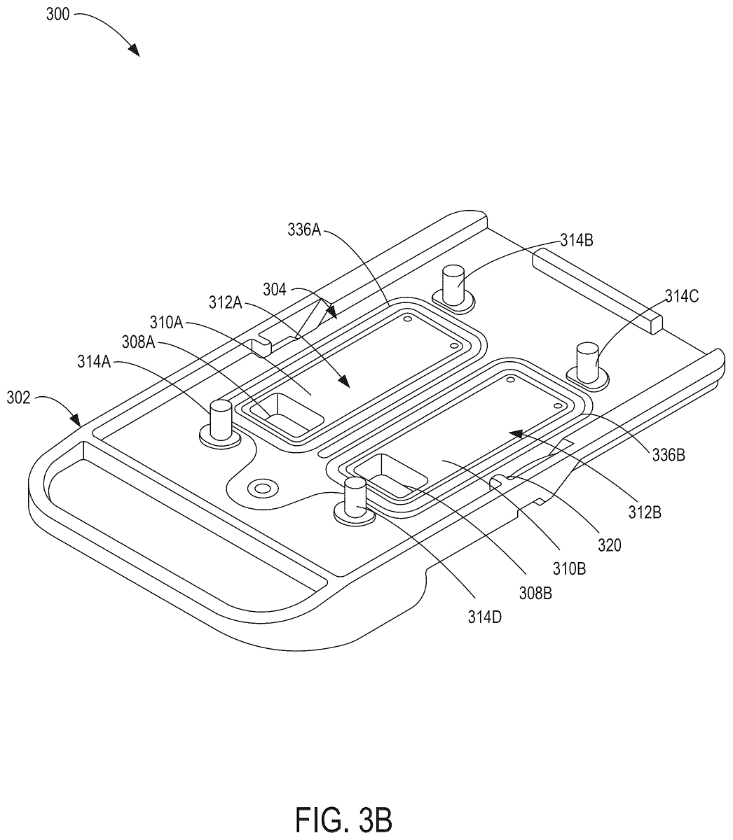

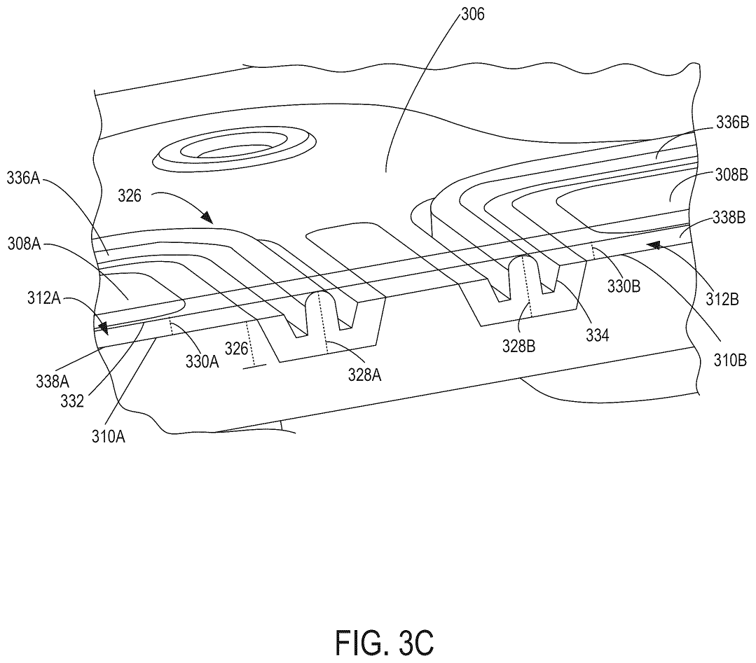

In example embodiments the housing 202 includes a port 208. The port 208 includes an aperture suitable for receiving a biological sample. For instance, in example embodiments, the port 208 is an opening that is large enough for a user to insert the biological sample (e.g., by inserting a needle and/or an applicator) into the port 208. In some example embodiments, the housing 202 includes a single port 208, as shown in FIG. 2A. Alternatively, in some examples, the housing 202 includes multiple ports (shown in FIGS. 3A-3B). Many example configurations are possible. Further, in examples, the port 208 is of a sufficient depth to avoid backflow of the biological sample once inserted into the cartridge 200A.

In example embodiments, the housing 202 additionally includes one or more recesses 210A and 210B. For instance, the housing 202 can include a first recess 210A and a second recess 210B. In example configurations, the recesses 210A and 210B can be adjacent to the port 208. The recesses 210A and 210B can each include a respective surface 238A and 238B which, when the cartridge 200A is assembled, forms one or more boundaries of a reservoir and/or, in some examples, a first reservoir 212A and a second reservoir 212B. In some example embodiments, the recess 210 includes a ridge 216. The ridge 216 can include one or more walls which protrude from portions of the recesses 210A and 210B and are adjacent to a portion of the port 208. In examples, when the cartridge 200A is assembled, the one or more walls of the ridge 216 form a boundary of the one or more reservoirs 212A and 212B. In some examples, as shown in FIG. 2A, the ridge 216 may divide the first reservoir 212A and the second reservoir 212B. In example implementations, the two reservoirs 212A and 212B can have two different heights. In examples, having two reservoirs of two different heights allows for performing multiple tests at once on a biological sample.

In example implementations, performing multiple tests at once, for instance, on a single biological sample, allows a user to conduct comparative analyses on a single biological sample that is divided and contained in each of the two reservoirs. In examples wherein the reservoirs 212A and 212B have two different heights, this arrangement can allow handling of a wider range of cellularity. For instance, images captured of a biological sample having a high cell concentration can be more clear and easier to interpret in a reservoir with a lower height than images of the same biological sample in a reservoir having a greater height, for example, due to crowding of cells. In another example, a biological sample having a low cell concentration may not have enough cells in the reservoir with the lower height to result in an adequate image for analysis, but can result in adequate images for testing in the reservoir with the higher height, for example, after settling. In examples, this arrangement can provide an improvement over current technologies by, for example, helping reduce testing time and/or the consistency of results and analysis over multiple test.

In example embodiments, the housing 202 also comprises a channel 220A. The channel 220A surrounds at least a portion of the recesses 210A and 210B and is configured to receive at least a portion of the gasket 204A. To facilitate the reception and/or disposal of the gasket in the channel, the channel 220A may have the same, or similar, cross-sectional shape as the gasket 204A. In examples, the channel 220A includes a concave portion on a surface of the housing 202, having a depth defined by a distance between the surface of the recess 210A or 210B and the base of the channel 220A (shown in FIG. 2E). Other example configurations of the channel 220A are possible.

In some examples, the housing 202 comprises one or more fasteners 214A, 214B, 214C, and 214D. The fasteners 214A, 214B, 214C, and 214D are configured to interface and/or couple the housing 202 to the sheet 206 to assemble the cartridge 200A, as shown in FIG. 2D and further described in the corresponding paragraphs. For instance, in some examples, the sheet 206 can include one or more apertures 222A, 222B, 222C, and 222D compatible with the one or more fasteners 214A, 214B, 214C, and 214D, respectively. In some example configurations, such as the configuration shown in FIG. 2A, the housing 202 can include four fasteners 214A, 214B, 214C, and 214D. Many example configurations of fasteners are possible. For instance, in some examples, the housing 202 can include fewer fasteners (e.g., one, two, or three fasteners). In other examples, the housing 202 can include more fasteners (e.g., five, six, or seven fasteners). In some examples, the fasteners 214A, 214B, 214C, and 214D further include one or more datum pads. Additionally or alternatively, the fasteners 214A, 214B, 214C, and 214D can include one or more heat stakes. In some alternative example embodiments, the housing 202 and the sheet 206 can be coupled to each other via an adhesive (e.g., a UV cured adhesive).

In examples, the housing 202 includes optically transparent materials suitable for imaging. For instance, some example materials suitable for the housing 202 can include, but are not limited to, glass, acrylic, polystyrene, polypropylene, poly (methyl methacrylate) (PMMA), cyclic olefin copolymer (COC), and cyclic olefin polymer (COP). Many example materials are possible. In example embodiments, the optically transparent housing 202 helps reduce autofluorescence from the housing 202 to provide a clear fluorescent background for imaging.

In example embodiments, the cartridge 200A further includes a gasket 204A configured to surround at least a portion of the first recess 210A and/or the second recess 210B when the cartridge 200A is assembled. To facilitate this, the gasket 204A can have the same, or similar cross-sectional shape of the channel 220A so that the gasket 204A can be received by the channel 220A. Additionally, the gasket 204A can include one or more walls 236 to form boundaries of the reservoirs 212A and 212B once the cartridge 200A is assembled. The height of the one or more walls 236 can vary between example embodiments to facilitate different reservoir heights and/or reservoir volumes.

In example embodiments, the gasket 204A can include compressible material. Example compressible materials can include, but are not limited to, TPE, TPU, SBCs, POEs, polyester-based TPEs, PVC compounds, EVA, and PU elastomers. Many example materials are possible.

In a further aspect, one or more of the first reservoir 212A and/or second reservoir 212B may comprises one or more vents. For instance, the first reservoir 212A can include a first vent 240A and second vent 240B. Additionally or alternatively, the second reservoir 212B can include a third vent 240C and a fourth vent 240D. In example embodiments, the vents 240A, 240B, 240C, and 240D may promote fluid communication within the respective reservoir, as the vents 240A, 240B, 240C, and 240D may promote a fluid (e.g., a biological testing sample) dispersing throughout the respective reservoir after being inserted and dispersed into port 208. Further, in examples, the vents 240A, 240B, 240C, and 240D may help avoid backflow of the biological testing sample once inserted into the cartridge 200A via port 208.

Additionally or alternatively, in some examples, the housing 202 may include a vent 242. In example implementations, the vent 242 can be on the channel 220A. In some examples, the vent 242 may be between the first reservoir 212A and the second reservoir 212B. In examples, the vent 242 may promote fluid communication within the cartridge 200A, as the vent 242 may promote a fluid (e.g., a biological testing sample) dispersing throughout the respective reservoir after being inserted and dispersed into port 208. Further, the vent 242 can promote fluid communication within the channel 220A during manufacturing. For instance, during manufacturing, the gasket 204A may be injection molded into the channel 220A. The vent 242 may promote a fluid (e.g., molten plastic) dispersing throughout the channel 220A after being inserted and dispersed into channel 220A.

In example embodiments, the cartridge 200A further includes sheet 206. As noted above, in examples, the sheet 206 can include one or more apertures 222A, 222B, 222C, and 222D compatible with the one or more fasteners 214A, 214B, 214C, and 214D. Additionally, the sheet can include a label 224. In some examples, the label 224 includes a machine-readable identifier (e.g., a barcode, a QR code, etc.). Further, in example embodiments, the label 224 may be a laser-etched label, a printed label, and/or an adhesive label (e.g., a sticker), among other possibilities. In a further aspect, in examples, the QR code may be used to identify one or more medical records associated with sample, the patient, the imaging machine, and/or the testing facility, among other possibilities. For example, the QR code may be used as a verification protocol between the imaging device and the cartridge (e.g., an electronic handshake protocol) to ensure the cartridge is the proper cartridge for the imaging device. In some examples, the label 224 can additionally or alternatively include human-readable identifiers. For instance, the human-readable identifier may be used to identify one or more medical records associated with sample, the patient, the imaging machine, and/or the testing facility, among other possibilities. Other examples are possible.

In examples, the sheet 206 includes optically transparent materials suitable for imaging. For instance, some example materials suitable for the sheet 206 can include, but are not limited to, glass, acrylic, polystyrene, polypropylene, PMMA, COC, and/or COP. Many example materials are possible. In some example embodiments, the material of the sheet 206 may be the same, or similar, to the material of the housing 202. In other examples, the material of the sheet 206 and the material of the housing 202 can be different from one another.

Now referring to FIG. 2B, to assemble the cartridge 200A, the gasket 204A can be disposed in the channel 220A. As noted above, the gasket 204A includes at least one wall 236 which surrounds at least a portion of the recess 210.

In example implementations, the height of the at least one wall 236 of the gasket 204A is greater than the depth of the channel 220A. As such, when the gasket 204A is disposed in the channel 220A, a portion of the wall extends past the surfaces of the recesses 210A and 210B. As such, when the gasket 204A is disposed in the channel 220A, the at least one wall 236 defines a boundary of the reservoirs 212A and 212B. In examples where the cartridge 200A includes two reservoirs 212A and 212B separated by the ridge 216, as shown in FIG. 2B, the gasket 204A can surround both reservoirs 212A and 212B. In these examples, the at least one wall of the gasket 204A defines the boundaries of both reservoirs 212A and 212B.

The wall height of the gasket 204A can vary between embodiments to facilitate different reservoir heights and/or reservoir volumes. In examples, the channel 220A is configured to receive at least a portion of a gasket of a variety of different heights. Namely, gaskets of different heights may have the have the same, or similar, cross-sectional shape across the different heights so that they can be placed in the channel 220A. This allows for varying heights and volumes of reservoirs 212A and 212B. As described above, different heights of reservoirs and volumes of reservoirs provides benefits for different types of tests to be performed and/or different types of samples to be tested.

In examples, the gasket 204A is held in place in the channel 220A by friction. For instance, in some examples the gasket 204A and/or channel 220A can include a material with a high coefficient of friction, so that when the gasket 204A interfaces with the channel 220A, the gasket 204A remains in place. In examples, the walls of the gasket 204A may be slightly wider than the width of the channel 220A to further increase frictional forces between the channel 220A and the gasket 204A. This prevents the gasket 204A from moving or dislodging during fabrication, transportation, storage, handling, and/or testing.

Additionally or alternatively, in some example embodiments, the gasket 204A may be coupled to the channel 220A (or another component of the housing 202) by way of an adhesive. For example, during fabrication, adhesive can be applied to the channel 220A and/or gasket 204A. The adhesive can help secure the gasket 204A in the channel 220A and prevent it from dislodging during fabrication, transportation, storage, and/or handling.

Now referring to FIG. 2C, an alternative example embodiment of a gasket 204B disposed within a channel 220B. In FIG. 2C, the cartridge 200B includes largely the same features as the cartridge 200A shown in FIGS. 2A and 2B and described in the corresponding description. However, the walls of the gasket 204B separate the two reservoirs 212A and 212B (rather than the ridge 216, shown in FIGS. 2A-2B). To facilitate this, the gasket 204B walls can extend inward from the perimeter of the gasket 204B. The channel 220B can have the same a similar cross-sectional shape as the gasket 204B so that it can receive and retain the gasket 204B. Further, the gasket 204B can surround both reservoirs 212A and 212B. In these examples, the walls of the gasket 204B define the boundaries of both reservoirs 212A and 212B. As noted above, having two reservoirs allows for performing multiple tests at once on a biological sample. In example implementations, performing multiple tests at once, for instance, on a single biological sample, allows a user to conduct comparative analyses on a single biological sample that is divided and contained in each of the two reservoirs. In examples, this arrangement can provide an improvement over current technologies by, for example, helping reduce testing time and/or the consistency of results and analysis over multiple tests.

Similar to gasket 204A, the wall 236 height of the gasket 204B can vary between example implementations. In examples, the channel 220B is compatible with (e.g., configured to receive at least a portion of) a gasket of a variety of different heights. Namely, gaskets of different heights may have the same, or similar, cross-sectional shape and dimensions so that they can be placed in the channel 220B. This allows for varying heights and volumes of reservoirs 212A and 212B between cartridges. Different heights and volumes of reservoirs 212A and 212B provides various benefits for different types of tests and/or different types of samples. By utilizing the same or similar components to assemble cartridges that can be used in a variety of use cases, assembly automation and reduced production time and cost may be realized.

Gasket 204B can include compressible material. Example compressible materials can include, but are not limited to TPE, TPU, SBCs, POEs, polyester-based TPEs, PVC compounds, EVA, and PU elastomers. Many example materials are possible.

In examples, the gasket 204B is held in place by friction. For instance, in some examples the gasket 204B and/or channel 220B can include a material with a high coefficient of friction, such that when the gasket 204B interfaces with the channel 220A, the gasket 204B remains in place. In examples, the walls of the gasket 204B may be slightly wider than the width of the channel 220B to further increase friction forces between the channel 220B and the gasket 204B. This prevents the gasket 204B from moving or dislodging during fabrication, transportation, storage, and/or handling.

Additionally or alternatively, in some example embodiments, the gasket 204B may be coupled to the channel 220B (or another component of the housing 202) by way of an adhesive. For example, during fabrication and/or assembly, adhesive can be applied to the channel 220B and/or gasket 204B. The adhesive can help secure the gasket 204B in the channel 220B and prevent it from dislodging during fabrication, transportation, storage, handling, and/or testing.

Now referring to FIG. 2D, an assembled cartridge 200B according to an example embodiment. Although FIG. 2D shows an assembled cartridge 200B with the configuration shown in FIG. 2C, the same, or similar, features and/or methods of assembly can be applicable for cartridge 200A shown in FIGS. 2A and 2B. Once the gasket 204B is in disposed in and/or received by the housing 202, the sheet 206 can be positioned to interface with at least one wall 236 of the gasket 204B. In some examples, the sheet 206 is further interfaced with or coupled to the housing 202 via fasteners 214A, 214B, 214C, and 214D. For instance, apertures 222A, 222B, 222C, and 222D are configured to align with the fasteners 214A, 214B, 214C, and 214D, respectively, so that the housing 202 and the sheet can interface and/or couple to one another.

In some examples, the fasteners 214A, 214B, 214C, and 214D include datum pads. Additionally, in some examples the fasteners 214A, 214B, 214C, and 214D include heat stakes. In these examples, once the sheet 206 is interfaced with the gasket 204B and the apertures 222A, 222B, 222C, and 222D, are aligned with the heat stakes, heat can be applied to the heat stakes (e.g., via a heat staking machine) causing the heat stakes to soften and/or partially melt. The heat stakes can then be flattened creating a backstop against the sheet 206 to hold it in place. Heat staking provides a versatile method of manufacturing and/or assembling the cartridge 200B. Further, heat staking can help facilitate the assembly of cartridges with a variety of different gasket heights. Other methods of coupling the housing 202 to the sheet 206 are possible.

As noted above, in some examples, the gasket 204B can include compressible material. The compressible material can provide shock absorption of the housing 202 and/or the sheet 206. This can help prevent cracking or breaking of the housing 202 and the sheet 206, for instance, during fabrication, transportation, storage, handling, and/or testing.

When the cartridge 200B is assembled, the reservoirs 212A and 212B are in fluid communication with the port 208. As such, in practice, the biological sample can be deposited into the reservoirs 212A and 212B via the port 208. The biological sample may then be dispersed from the port 208 into the reservoirs 212A and 212B by kinetic force from dispensing the biological sample and/or capillary action. In examples, the biological sample can similarly be dispersed from the port 208 into both reservoirs 212A and 212B. In these examples, the at least one wall 236 of the gasket 204B (or the at least one wall of the ridge 216 shown in FIGS. 2A and 2B) keep the biological sample in each reservoir separated from the other reservoir during handling and testing. While the example configuration shown in FIG. 2D illustrates the sheet 206 positioned above the housing 202, in practice, the cartridge 200B can be positioned with the housing 202 above the sheet 206. This allows a user to more easily deposit the biological sample into the reservoirs 212A and 212B via the port 208. This also prevents spillage, leakage, and/or backflow of the biological sample from the port 208.

Now referring to FIG. 2E, a cross-sectional view of a portion of the assembled cartridge 200B, according to an example embodiment. More particularly, FIG. 2E illustrates a cross-sectional view of the gasket 204B, the housing 202, and the sheet 206 according to an example embodiment. In the example shown in FIG. 2E, the cartridge 200B, includes two reservoirs 212A and 212B. As shown in FIG. 2E, in examples, a height 228A of a first wall 236A of the gasket 204B is greater than a depth 226A of channel 220B. The difference between the height 228A of the first wall 236A and the depth 226A of the channel 220B defines a height 230A of the first reservoir 212A. The first reservoir 212A is defined as the area between the first wall 236A of the gasket 204B, the first recess 210A, and the sheet 206. Further, a height 228B of a second wall 236B of the gasket 204B is greater than a depth 226B of channel 220B. The difference between the height 228B of the second wall 236A and the depth 226B of the channel 220B defines a height 230B of the second reservoir 212B. The second reservoir 212B is defined as the area between the second wall 236B of the gasket 204B, the second recess 210B, and the sheet 206.

In examples, the heights 230A and 230B of the first reservoir 212A and the second reservoir 212B can range from 50 microns to 500 microns. In example embodiments, the height 230A of the first reservoir 212A can be different than the height 230B of the second reservoir 212B. For instance, in one example, the height 230A of the first reservoir 212A can be 100 microns and the height 230B of the second reservoir 212B can be 300 microns. In another example, the height 230A of the first reservoir 212A can be 200 microns and the height 230B of the second reservoir 212B can be 400 microns.

Additionally, in an example embodiment, the first reservoir 212A and/or the second reservoir 212B may have a sloped surface (e.g., surface 232A and/or surface 232B) so that there are different heights within the reservoir. For example, the first reservoir 212A may have a height of 100 microns at a first end, near the port 208, and 200 microns at a second end, opposite the first end, (e.g., near the label 224). Additionally or alternatively, the first reservoir 212A and/or the second reservoir 212B may have different heights within the respective reservoirs. In this example, because one or both of first reservoir 212A and second reservoir 212B contain two different recess heights, a user can perform testing protocols (e.g., imaging) at multiple depths within the same reservoir on the same the sample. For example, a user may perform a first analysis of a biological testing sample (e.g., capture a first set of images) in the first reservoir 212A at the shallow portion and a second analysis of the same biological testing sample (e.g., capture a second set of images) in the first reservoir 212A at the deeper portion. In examples, this arrangement can provide an improvement over current technologies by, for example, helping reduce testing time and/or the consistency of results and analysis over multiple tests. Further, a user can perform two different testing protocols on the same biological testing sample at once. Further, a user can also perform tests with up to four different reservoir heights at once. Many example reservoir depths and configurations are possible.

Different heights and volumes of a reservoir can have advantages depending on the type of testing performed and/or the type of biological sample being tested. For instance, images captured of a biological sample having a high cell concentration can be more clear and easier to interpret in a reservoir with a lower height than images of the same biological sample in a reservoir having a greater height, for example, due to crowding of cells. In another example, a biological sample having a low cell concentration may not have enough cells in the reservoir with the lower height to result in an adequate image for analysis, but can result in adequate images for testing in the reservoir with the higher height, for example, after settling.

Further, for imaging fluid samples (e.g., blood), a shallow reservoir having a smaller reservoir height and volume can be more beneficial to help facilitate dispersing the biological sample into a thinner, more even layer. As such, imaging of a fluid sample may be more uniform which can improve consistency, accuracy, and repeatability of tests. Alternatively, in examples where the biological sample includes a solid sample (e.g., ear wax, fecal matter), it may be more beneficial to have a higher reservoir height, and thus a greater reservoir height and volume, to allow sufficient space for the sample to be imaged and/or mix with one or more liquids (e.g., a diluent and/or stain), among other possibilities.

In some examples, the gasket 204B includes one or more overflow channels 234. Namely, the one or more overflow channels 234 are positioned adjacent to the reservoirs 212A and 212B and can retain excess biological sample. These overflow channels 234 prevent back flow of the biological sample (e.g., out of the port 208) which helps prevent leakage and/or spillage.

Referring back to FIG. 2D, an additional feature of the example cartridge 200B can include a label 224. In some examples, the label 224 includes a machine-readable identifier (e.g., a barcode, a QR code, etc). Further, in example embodiments, the label 224 may be a laser-etched label, a printed label, and/or an adhesive label (e.g., a sticker), among other possibilities. In a further aspect, in examples, the QR code may be used to identify one or more medical records associated with sample, the patient, the imaging machine, and/or the testing facility, among other possibilities. For example, the QR code may be used as a verification protocol between the imaging device and the cartridge (e.g., an electronic handshake protocol) to ensure the cartridge is the proper cartridge for the imaging device. In some examples, the label 224 can additionally or alternatively include human-readable identifiers. For instance, the human-readable identifier may be used to identify one or more medical records associated with sample, the patient, the imaging machine, and/or the testing facility, among other possibilities. Other examples are possible.

Additionally, or alternatively, in some example embodiments, the housing 202 can include a marking area. A marking area allows a user to manually mark this area to create a label for a cartridge, for instance to note the patient identification. Additionally or alternatively, the user can attach a label (e.g., a sticker). The label may be used to identify one or more medical records associated with sample, the patient, the imaging machine, and/or the testing facility, among other possibilities. For example, the label may be used as a verification protocol between the imaging device and the cartridge (e.g., an electronic handshake protocol) to ensure the cartridge is the proper cartridge for the imaging device. Other examples are possible.

Now referring to FIG. 3A, a cartridge 300 according to an example embodiment. In FIG. 2C, the cartridge 300 includes largely the same features as the cartridges 200A and 200B shown in FIGS. 2A and 2B and described in the corresponding description. For instance, the cartridge 300 includes a housing 302 and a gasket 304. However, cartridge 300 includes a first port 308A and a second port 308B. Additionally, the gasket 304 includes a first wall 336A and a second wall 336B. Further, the housing 302 includes a first recess 310A and a second recess 310B. When the cartridge 300 is assembled, the first port 308A is in fluid communication with a first reservoir 312A and the second port 308B is in fluid communication with a second reservoir 312B. In these examples, when the gasket 304 is disposed in a channel 320 of the housing 302 (as shown in FIGS. 3B and 3C), boundaries of a first reservoir 312A are defined by the first recess 310A, the first wall 336A of the gasket 304A, and a surface of a sheet (such as sheet 206 shown in FIGS. 2A-2E). In examples, the height of the first reservoir 312A may be different than the height of the second reservoir 312B. Although FIGS. 3A-3B do not show a sheet, such as sheet 206, an assembled two-port cartridge 300 includes the same, or similar, sheet as shown in FIGS. 2A-2E. Assembly of the two-port cartridge 300 can be completed utilizing any of the methods described herein.

The two-port cartridge 300 facilitates testing of multiple biological samples at once. For instance, in some examples, a user can test ear wax samples from a left ear and a right ear simultaneously. Additionally, a user can deposit a biological sample collected from the same source in both the first reservoir 312A and the second reservoir 312B which allows the user to conduct comparative analyses on biological samples contained in each of the two reservoirs. In examples, this arrangement can provide an improvement over current technologies by, for example, helping reduce testing time and/or the consistency of results and analysis over multiple tests. Further, a user can perform a single testing protocol on of two different biological samples at once. Additionally or alternatively, a user can prepare one biological sample with two separate reagents. In these examples, this allows a user to chemically remove some of the elements in the biological sample or preferentially stain different elements to aid in detection. Further, a user can also perform tests with two different reservoir heights at once. In example implementations, performing multiple tests at once, for instance, two biological samples, can help reduce testing time and consistency among tests.

To facilitate the reception and/or disposal of the gasket 304 in the channel 320, the channel 320 the same or similar cross-sectional shape as the gasket 304. In example embodiments, the gasket 304 and channel 320 may both include two portions to surround the first recess 310A and the second recess 310B, respectively. For instance, the first wall 336A of the gasket 304B can be configured to surround the first recess 310A and the second wall 336B of the gasket 304 can be configured to surround the second recess 310B. In these examples, the walls of the gasket 304 define the boundaries of the first reservoir 312A and the second reservoir 312B. As noted above, having two separate reservoirs 312A and 312B allows for performing multiple tests at once. As noted above, performing multiple tests at once can improve accuracy and efficiency and can, in some examples, allow a user to perform a comparative analysis, if desired.

In some examples, the housing 302 comprises one or more fasteners 314A, 314B, 314C, and 314D. The fasteners 314A, 314B, 314C, and 314D are configured to interface and/or couple the housing 302 to a sheet (e.g., sheet 206, sheet 306, or similar) to assemble the cartridge 300, similar to the assembled cartridge 200B shown in FIG. 2D and further described in the corresponding paragraphs. For instance, in some examples, a sheet 206 can include one or more apertures compatible with the one or more fasteners 314A, 314B, 314C, and 314D. In some example configurations, such as the configuration shown in FIG. 3A, the housing 302 can include four fasteners 314A, 314B, 314C, and 314D. Many example configurations of fasteners are possible. For instance, in some examples, the housing 302 can include fewer fasteners (e.g., one, two, or three fasteners). In other examples, the housing 202 can include more fasteners (e.g., five, six, or seven fasteners). In some examples, the fasteners 314A, 314B, 314C, and 314D include one or more datum pads. Additionally or alternatively, the fasteners 314A, 314B, 314C, and 314D can include one or more heat stakes. In some alternative example embodiments, the housing 302 and a sheet (e.g., sheet 206 shown in FIGS. 2A-2E and/or sheet 306 shown in FIG. 3C) can be coupled to each other via an adhesive (e.g., a UV cured adhesive).

In a further aspect, one or more of the first reservoir 312A and/or second reservoir 312B may comprises one or more vents. For instance, the first reservoir 312A can include a first vent 340A and second vent 340B. Additionally or alternatively, the second reservoir 312B can include a third vent 340C and a fourth vent 340D. In example embodiments, the vents 340A, 340B, 340C, and 340D may promote fluid communication within the respective reservoir, as the vents 340A, 340B, 340C, and 340D may promote a fluid (e.g., a biological testing sample) dispersing throughout the respective reservoir after being inserted and dispersed into port 308A or port 308B. Further, in examples, the vents 340A, 340B, 340C, and 340D may help avoid backflow of the biological testing sample once inserted into the cartridge 300 via port 308A or 308B.

Additionally or alternatively, in some examples, the housing 302 may include additional vents 342A, 342B, 342C, and 342D. In example implementations, the vents 342A, 342B, 342C, and 342D can be on the channel 320. In examples, the vents 342A, 342B, 342C, and 342D may promote fluid communication within the cartridge 300, as the vents 342A, 342B, 342C, and 342D may promote a fluid (e.g., a biological testing sample) dispersing throughout the respective reservoir after being inserted and dispersed into port 308A or port 308B. Further, the vents 342A, 342B, 342C, and 342D can promote fluid communication within the channel 320 during manufacturing. For instance, during manufacturing, the gasket 304 may be injection molded into the channel 320. The vents 342A, 342B, 342C, and 342D may promote a fluid (e.g., molten plastic) dispersing throughout the channel 320 after being inserted and dispersed into channel 320.

Now referring to FIG. 3B, a gasket 304 disposed in the channel 320 of the housing 302. Similar to gaskets 204A and 204B, the wall height of the gasket 304 can vary between example embodiments. In examples, the channel 320 is configured to receive at least a portion of a gasket of a variety of different heights. Namely, gaskets of different heights may have the same, or similar, cross-sectional shape and dimensions so that they can be placed in the channel 320. This allows for varying reservoir heights and reservoir volumes. Different depths and volumes of reservoirs 312A and 312B provide various benefits for different types of tests and/or different types of samples.

Gasket 304 can include compressible material. Example compressible materials can include, but are not limited to TPE, TPU, SBCs, POEs, polyester-based TPEs, PVC compounds, EVA, and PU elastomers. Many example materials are possible.

In examples, the gasket 304 is held in place by friction between the surface of the gasket and the surface of the channel 320. For instance, in some examples the surface of the gasket 304 and/or channel 320 can include a material with a high coefficient of friction, such that when the gasket 304 interfaces with the channel 320, the gasket 304 remains in place. In examples, the walls 336A and 336B of the gasket may be slightly wider than the width of the channel 320 to further increase friction forces between the channel 320 and the gasket 304. This prevents the gasket 304 from moving or dislodging during fabrication, transportation, storage, handling, and/or testing.

Additionally or alternatively, in some example embodiments, the gasket 304 may be coupled to the channel 320 by way of an adhesive. For example, during fabrication, adhesive can be applied to the channel 320 and/or gasket 304. The adhesive can help secure the gasket 204B in the channel 220B and prevent it from dislodging during fabrication, transportation, storage, handling, and/or testing.

Now referring to FIG. 3C, a cross-sectional view of a portion of the assembled cartridge 300, according to an example embodiment. More particularly, FIG. 3C illustrates a cross-sectional view of the gasket 304, the housing 302, and a sheet 306 according to an example embodiment. As shown in FIG. 3C, in examples, a height 328A of a first wall 336A of the gasket 304 is greater than a depth 326 of the channel 320. The difference between the height 328A of the first wall 236A and the depth 326 of the channel 320 defines the height 330A of the first reservoir 312A. An area of the first reservoir 312A are defined at least by the first wall 336A of the gasket 304, the surface 338A of the first recess 310A, and a surface 332 of the sheet 306. Similarly, a height 328B of the second wall 336B of the gasket 304 is greater than the depth 326 of the channel 320. The difference between the height 328B of the second wall 336B and the depth 326 of the channel 320 defines the height 330B of the second reservoir 312B. The area of the second reservoir 312B are defined at least by the second wall 336B of the gasket 304, the surface 338B of the second recess 310B, and a surface 332 of the sheet 306.

In example embodiments, the height 330A of the first reservoir 312A is different from the height 330B of the second reservoir 312B. In examples, the heights 330A and 330B of the first reservoir 312A and the second reservoir 312B can range from 50 microns to 500 microns. In example embodiments, the height 330A of the first reservoir 312A can be different than the height 330B of the second reservoir 312B. For instance, in one example, the height 330A of the first reservoir 312A can be 100 microns and the height 330B of the second reservoir 312B can be 300 microns. In another example, the height 330A of the first reservoir 312A can be 200 microns and the height 330B of the second reservoir 312B can be 400 microns. Additionally, in an example embodiment, the first reservoir 312A and/or the second reservoir 312B may have a sloped surface (e.g., surface 332A and/or surface 332B) so that there are different heights within the reservoir. For example, the first reservoir 312A may have a height of 100 microns at a first end, near the port 308A, and 200 microns at a second end, opposite the first end, (e.g., near the label 224). Many example reservoir depths and configurations are possible. Additionally or alternatively, the first reservoir 312A and/or the second reservoir 312B may have different heights within the respective reservoirs. In this example, because one or both of first reservoir 312A and second reservoir 312B contain two different recess heights, a user can perform testing protocols (e.g., imaging) at multiple depths within the same reservoir on the same the sample. For example, a user may perform a first analysis of a biological testing sample (e.g., capture a first set of images) in the first reservoir 312A at the shallow portion and a second analysis of the same biological testing sample (e.g., capture a second set of images) in the first reservoir 312A at the deeper portion. In examples, this arrangement can provide an improvement over current technologies by, for example, helping reduce testing time and/or the consistency of results and analysis over multiple tests. Further, a user can perform two different testing protocols on the same biological testing sample at once. Further, a user can also perform tests with up to four different reservoir heights at once.

Different heights and volumes of a reservoir can have advantages depending on the type of testing performed and/or the type of biological sample being tested. For instance, images captured of a biological sample having a high cell concentration can be more clear and easier to interpret in a reservoir with a lower height than images of the same biological sample in a reservoir having a greater height, for example, due to crowding of cells. In another example, a biological sample having a low cell concentration may not have enough cells in the reservoir with the lower height to result in an adequate image for analysis, but can result in adequate images for testing in the reservoir with the higher height, for example, after settling.

Further, for imaging fluid samples (e.g., blood), a shallow reservoir 312A and 312B having a smaller reservoir height 330A and 330B and volume can be more beneficial to help facilitate dispersing the biological sample into a thinner, more even layer. As such, imaging of a fluid sample may be more uniform which can improve consistency, accuracy, and repeatability of tests. Alternatively, in examples where the biological sample includes a solid sample (e.g., ear wax, fecal matter), it may be more beneficial to have a higher reservoir height 330A and 330B, and thus a greater reservoir height and volume, to allow sufficient space for the sample to be imaged and/or mix with one or more liquids (e.g., a diluent and/or stain), among other possibilities.

In some examples, the gasket 304 includes one or more overflow channels 334. Namely, the one or more overflow channels 334 are positioned adjacent to one, or both of, the first reservoir 312A and the second reservoir 312B and can retain excess biological sample. This overflow channel 334 prevents back flow of the biological sample (e.g., out of the first port 308A and/or the second port 308B) which helps prevent leakage and/or spillage.

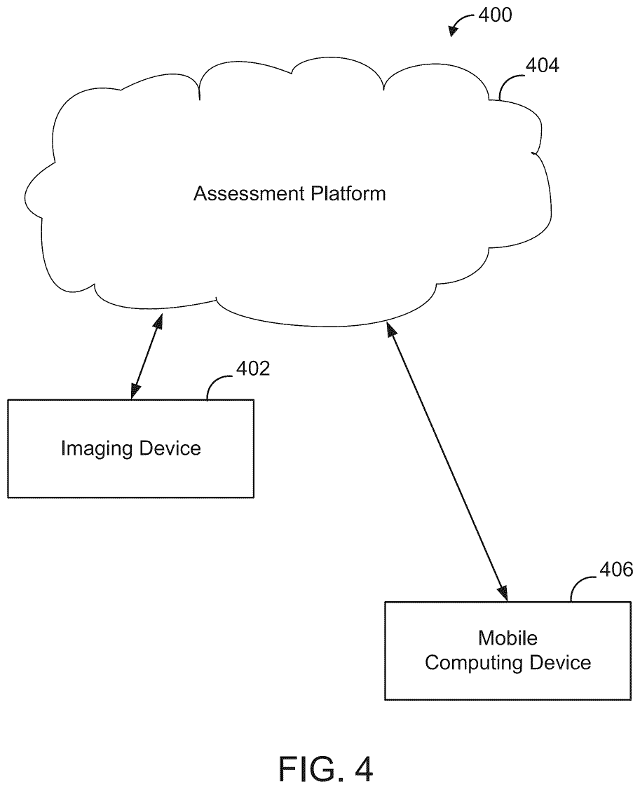

Now referring to FIG. 4, a computing system 400 configured for use with an imaging device 402 and a mobile computing device 406, according to an example embodiment. Example cartridges (e.g., 200A, 200B, and 300) are compatible with an imaging device 402. An imaging device 402 includes a computing device, such as computing device 100. It should also be readily understood that computing device 100 and the imaging device 402, and all of the components thereof, can be physical systems made up of physical devices, cloud-based systems made up of cloud-based devices that store program logic and/or data of cloud-based applications and/or services (e.g., perform at least one function of a software application or an application platform for computing systems and devices detailed herein), or some combination of the two.

In any event, a computing system 400 can include various components, such as the computing device 100, imaging device 402, a cloud-based assessment platform.

The imaging device 402 and/or components thereof can perform various acts and/or functions (many of which are described above). Examples of these and related features will now be described in further detail.

The imaging device 402 may collect data from a number of sources. In one example, the imaging device 402 may collect data from a database of images related to assays and microscopic analyses of biological samples, including one or more images of biological samples. The images may be uploaded to an assessment platform 404 and characteristics of the images may be output to a mobile computing device 406.

In an example, assessment platform 404 may collect data from one or more sensors communicably coupled to the imaging device 402, such as an imaging sensor, concerning a particular biological sample. In such examples, the assessment platform 404 may identify a characteristic of the biological sample and transmit instructions to the mobile computing device 406 to cause a graphical user interface to display a graphical indication of the identified characteristic. In some examples, the assessment platform 404 may determine a characteristic of the biological sample by utilizing one or more of: (i) an artificial neural network, (ii) a support vector machine, (iii) a regression tree, or (iv) an ensemble of regression trees.

In another example, the imaging device 402 may collect data from one or more sensors communicably coupled to the imaging device, such as an imaging sensor, concerning a particular biological sample. In some examples, the assessment platform 404 may determine a characteristic of the biological sample by utilizing one or more of: (i) an artificial neural network, (ii) a support vector machine, (iii) a regression tree, or (iv) an ensemble of regression trees.

In some examples, images that are captured by the imaging device can be stored within a memory, such as a memory of computing device 100, to be subsequently analyzed.

In another example, the imaging device 402 may collect data from a plurality of sensors of the imaging device and superimpose the data. For example, assessment platform 404 may collect data in the form of monochromatic images (e.g., from different wavelength sources) from an imaging sensor of imaging device 402, and thermal data from a thermal imaging sensor of imaging device 402 and then overlay the thermal image with the monochromatic image. In some examples, assessment platform 404 may collect data from a sensor of the imaging device 402 and input data from a user of the mobile computing device 406 or a user of the imaging device 402. In one example, assessment platform 404 may transmit instructions to cause a graphical user interface to display a graphical indication of an identified characteristic along with the input data received from a user of the mobile computing device 406 or a user of the imaging device 402.

In one example, the imaging device 402 may train a machine learning model using data associated images of biological samples that share a characteristic with captured images of biological samples. The machine learning model may be trained using training data that shares a characteristic with a biological sample to be analyzed by the imaging device. Training the machine learning model may include inputting one or more training images into the machine learning model, predicting, by the machine learning model, an outcome of a determined condition of the one or more training images, comparing the at least one outcome to the characteristic of the one or more training images, and adjusting, based on the comparison, the machine learning model. For example, if a user is attempting to develop assays and microscopic analysis of blood samples to determine blood cell count, the machine learning model may be trained by inputting images of blood samples with known blood cell counts, predicting, by the machine learning model, a blood cell count of one or more training images, comparing the predicted blood cell count to the known blood cell count, and adjusting, based on the comparison, the machine learning model.

In some examples, the training data may include labeled input images (supervised learning), partially labeled input images (semi-supervised learning), or unlabeled input images (unsupervised learning). In some examples, training may include reinforcement learning.

The machine learning model may include an artificial neural network, a support vector machine, a regression tree, an ensemble of regression trees, or some other machine learning model architecture or combination of architectures.

The training data may include images of dry samples, images of fluid biological samples, images of solid biological samples, images of mixed fluid samples including biological samples and a stain configured to react in an aqueous solution, images of blank slides, synthetic, augmented images, or any combination thereof.

In some examples, the machine learning model of the imaging device 402 may be adjusted based on training such that if the outcome of a determined condition matches the characteristic of the training images, the machine learning model is reinforced and if the outcome of a determined condition does not match the characteristic of the training images, the machine learning model is modified. In some examples, modifying the machine learning model includes increasing or decreasing a weight of a factor within the neural network of the machine learning model. In other examples, modifying the machine learning model includes adding or subtracting rules during the training of the machine learning model.

Once the imaging device 402 has determined a characteristic of a biological sample in one or more images, the imaging device may transmit instructions that cause a computing device (e.g., the computing device 100) to display one or more graphical indications of the identified characteristic and/or the enhanced image.

In example embodiments, the cartridge can be used for a variety of tests. For instance, these tests may include imaging of one or more of the following: (i) blood; (ii) urine; (iii) saliva; (iv) fecal matter; (v) secretion; (vi) excretion; (vii) FNA; (viii) lavage fluids; (ix) body cavity fluids; (x) semen; (xi) ear wax; (xii) skin cells; (xiii) biopsied samples, (xiv) exotics; (xv) cultured cells; (xvi) bacteria; (xvii) worms; (xviii) parasites; and (xix) ear mites, among other possibilities. Test may additionally include one or more of the following: blood coagulation test, polymerase chain reaction (PCR) test, and/or immunoassay, among other possibilities. For example, in some example embodiments, these tests may include one or more of the following blood chemistry tests: SDMA, Total T4 (TT4), Bile Acids, C-reactive Protein (CRP), Progesterone, Fructosamine, and/or Phenobarbital (PHBR), among other possibilities. For example, in some example embodiments, these tests may include one or more of the following blood chemistry profile tests that measure one or more of the following: ALB, ALB/GLOB, ALKP, ALT, AMYL, AST, BUN, BUN/CREA, Ca, CHOL, CK, Cl, CREA, CRP, FRU, GGT, GLOB, GLU, K, LAC, LDH, LIPA, Mg, Na, NH₃, PHOS, TBIL, TP, TRIG and/or URIC, among other possibilities. Other examples are possible.

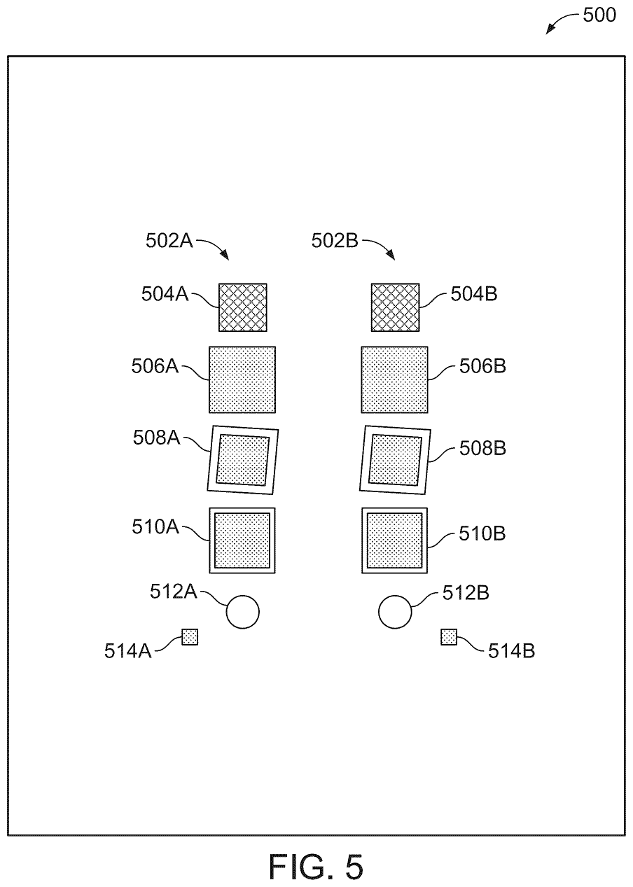

Now referring to FIG. 5, a cartridge 500 for calibrating an imaging device, according to an example embodiment. Cartridges, such as cartridge 500, can be used to calibrate one or more portions of an imaging device, such as imaging device 402. Imaging devices may vary between devices based on a number of factors including, but not limited to, optical capabilities, settings, position, and/or environmental elements. For example, when a cartridge is placed into an imaging device for imaging, the imaging device and/or one or more components thereof may cause a misalignment of the cartridge (e.g., tilt) which can result in an unclear and/or skewed images during capture. In example embodiments, one or more methods, systems, and/or device to improve the calibration of imaging devices can help improve the accuracy and quality of captured images.

In FIG. 5, to calibrate an example imaging device, an example cartridge 500 can include one or more targets for imaging. In examples, these targets can be used, for example, during microscope manufacture, installation, and/or maintenance. In examples, one or more targets can include one or more binary patterns which can be designed for specific measurements of interest to assess several parameters of the imaging device. In examples, parameters such as resolution (e.g., for each spectral band), optimal focus position, color offset, depth of field, tilt, modulation transfer function (MTF), color Z offset, distortion, field of view, magnification, illumination (e.g., brightness level and/or uniformity), and/or Z-parallelism to optics axis can be assessed. For instance, a computing device (e.g., computing device 100 and/or computing system 400) can analyze images of the one or more targets to measure and report imaging device capabilities against acceptance criteria and/or calculate calibration values.

In example embodiments, the cartridge 500 includes a first array 502A of targets 504A, 506A, 508A, 510A, 512A, and 514A and a second array 502B of targets 504B, 506B, 508B, 510B, 512B, and 514B. In example embodiments, each array 502A and 502B is at, or near, the viewing area of the biological sample. For instance, the first array 502A is at or near a position of a first reservoir containing the biological sample (e.g., reservoir 212A shown in FIGS. 2A-2E and reservoir 312A shown in FIGS. 3A-3C) when the cartridge (e.g., cartridges 200A, 200B and/or 300 shown in FIGS. 2A-3C) is placed in the imaging device. The second array 502B is at or near a position of a second reservoir containing the biological sample (e.g., reservoir 212B shown in FIGS. 2A-2E and reservoir 312B shown in FIGS. 3A-3C) when the cartridge (e.g., cartridges 200A, 200B and/or 300 shown in FIGS. 2A-3C) is placed in the imaging machine. This is beneficial to assess the imaging device parameters at or near where images of the biological sample will be captured.

In another example embodiment, the targets can be at another position on the cartridge 500. For instance, one or more targets could be positioned at or near the label 224 (as shown in FIGS. 2A-2D).

In some example configurations, such as the configuration shown in FIG. 5, each array 502A and 502B can include six targets. Many example configurations of arrays are possible. For instance, in some examples, the first array 502A and/or second array 502B can include fewer targets (e.g., one, two, three, four, or five targets). In other examples, the first array 502A and/or second array 502B can include more targets (e.g., seven, eight, nine, or ten targets).

Example target patterns can include, but are not limited to, rotated rectangles and/or checkerboards, dot patterns, and fixed frequency line pairs, among other possibilities. In some example embodiments, the first array 502A and the second array 502B include the same series of target patterns. For instance, the pattern of target 504A is the same, or similar, as the pattern of target 504B, the pattern of target 506A is the same, or similar, as the pattern of target 506B, and so on. In addition to assessing the parameters of the imaging device, this configuration can facilitate a comparative analysis between targets of the same pattern (e.g., target 504A and target 504B), for example, to perform a quality control protocol on each of the targets. In another example embodiment, the series of target patterns of the first array 502A can be different from the series of target patterns of the second array 502B. Many example configurations are possible.

Certain patterns can be designed for specific measurements of interest. For instance, in examples, slanted edges and/or checkerboards, rotated rectangles, or similar edges (e.g., patterns of targets 508A, 508B, 510A, and/or 510B) can be used for MTF measurements at various locations within the field of view. Additionally or alternatively, these patterns can be used for measuring resolution. In these examples, because the pattern feature sizes are known and periodic, parameters such as magnification and distortion can be measured simultaneously. In other examples, certain patterns, such as dot patterns (e.g., patterns of targets 504A, 504B, 506A, 506B, 514A, and/or 514B), are more useful when assessed by a human operator. For instance, dot patterns can be helpful in visualizing sample tilt, for example, where the dots appear larger when out of focus. Additionally or alternatively, chrome alignment features (e.g., features of targets 510A, 510B, 512A, 512B, 514A, and/or 514B) can be used for various measurements at various locations within the field of view. As shown in FIG. 5, in examples, each array 502A and 502B can include a variety of these patterns to assess a number of different parameters of the imaging device.

In some examples, one or more targets in a target array 502A and 502B can include one or more fluorescent features to assess the color functionality and illumination parameters of an imaging device. For instance, in some examples, a target can include fluorescent glass. In these examples, the fluorescent glass can help assess color offset parameters and/or the resolution of different colors.

In some examples, one or more of the target patterns allows one or more portions of the calibration to be done using a single target. For instance, a target can include one or more binary patterns which can be designed for specific measurements of interest to assess several parameters of the imaging device. In examples, a target pattern (e.g., checkerboard, rotated rectangles, or other patterns including slanted edge features, such as patterns of targets 508A, 508B, 510A, 510B, 514A, and/or 514B) can be designed to evaluate several imaging device parameters at once. In this manner, parameters such as resolution (e.g., for each spectral band), optimal focus position, color offset, depth of field, tilt, MTF, color Z offset, distortion, field of view, magnification, illumination (e.g., brightness level and/or uniformity) and/or Z-parallelism to optics axis can be assessed using a single target. In these examples, a pattern can additionally including one or more fluorescent features to help assess the color functionality and illumination parameters of an imaging device.

In example embodiments, one or more of the patterns of one or more of the targets have a low-level opacity (e.g., between a 4:1 contrast and a 10:1 contrast). A low-level opacity helps more accurately measure dark to light transitions needed for determining MTF measurements.

In examples, the targets are created using lithography techniques. For instance, in some examples, the targets can be created using high-resolution chrome-on-glass lithography. Additionally or alternatively, targets can be created using e-beam lithography. Other examples are possible.

In example embodiments, the target pattern can include features as small as 1 micrometer, for example, which may be similar to the resolution of an example imaging device. In examples, the target pattern may be manufactured at a significantly higher resolution (e.g., 10 times higher) in order to accurately create the target pattern feature. As such, the target pattern feature resolution may be as small as 100 nanometers, for example, so that the target pattern feature is a significantly higher resolution than an imaging device.

In an example, an imaging device (such as imaging device 402 shown in FIG. 4) can train a machine learning model using data associated with images of the same or similar targets. Generally, training the machine learning model may include inputting one or more training images of the targets into the machine learning model, predicting, by the machine learning model, an outcome of a determined condition of the one or more training images, comparing the at least one outcome to the characteristic of the one or more training images, and adjusting, based on the comparison, the machine learning model. Additionally or alternatively, in some examples, computer vision techniques can also be employed to identify and process characteristics of a target in an image.

In example implementations, once parameters of the imaging device are determined and assessed, these parameters can be used to calibrate the imaging device. The imaging device can store these parameters (e.g., via a memory of computing device 100) to be utilized and/or applied during subsequent imaging. An imaging device can be calibrated by way of the cartridge 500 periodically over time to assess any changes of the parameters of the imaging device.

### EXAMPLE METHODS AND ASPECTS

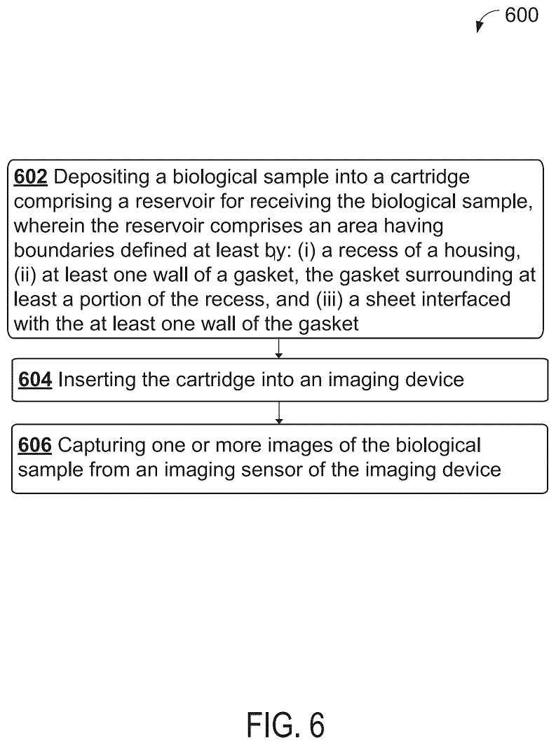

Now referring to FIG. 6, an example method of imaging a biological sample. Method 600 shown in FIG. 6 presents an example of a method of imaging a biological sample that could be used such as the example cartridges and/or imaging device shown in FIGS. 2A-4, for example. Further, devices or systems may be used or configured to perform logical functions presented in FIG. 6. In other examples, components of the devices and/or systems may be arranged to be adapted to, capable of, or suited for performing the functions, such as when operated in a specific manner. Method 600 may include one or more operations, functions, or actions as illustrated by one or more of blocks 602-606. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 602, method 600 involves depositing a biological sample into a cartridge comprising a reservoir for receiving the biological sample, wherein the reservoir comprises an area having boundaries defined at least by: (i) a recess of a housing, (ii) at least one wall of a gasket, the gasket surrounding at least a portion of the recess, and (iii) a sheet interfaced with the at least one wall of the gasket.

At block 604, method 600 involves inserting the cartridge into an imaging device.

At block 606, method 600 involves capturing one or more images of the biological sample from an imaging sensor of the imaging device.

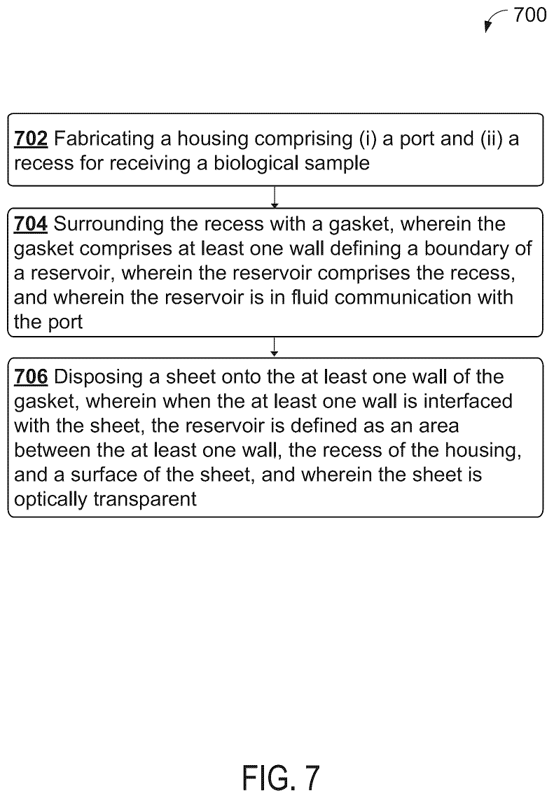

Now referring to FIG. 7, an example method of manufacturing a cartridge for imaging a biological sample. Method 700 shown in FIG. 7 presents an example of a method for manufacturing a cartridge for imaging a biological sample that could be used such as the example cartridges and/or imaging device shown in FIGS. 2A-4, for example. Further, devices or systems may be used or configured to perform logical functions presented in FIG. 7. In other examples, components of the devices and/or systems may be arranged to be adapted to, capable of, or suited for performing the functions, such as when operated in a specific manner. Method 700 may include one or more operations, functions, or actions as illustrated by one or more of blocks 702-706. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 702, method 700 involves fabricating a housing comprising (i) a port and (ii) a recess for receiving a biological sample. In some examples, the housing is optically transparent. Further, in some examples, the biological sample comprises one or more of the following: (i) blood; (ii) urine; (iii) saliva; (iv) fecal matter; (v) secretion; (vi) excretion; and (vii) ear wax.

At block 704, method 700 involves surrounding the recess with a gasket, wherein the gasket comprises at least one wall defining a boundary of a reservoir, wherein the reservoir comprises the recess, and wherein the reservoir is in fluid communication with the port. In some examples, block 704 involves disposing the gasket into a channel of the housing.

At block 706, method 700 involves disposing a sheet onto the at least one wall of the gasket, wherein when the at least one wall is interfaced with the sheet, the reservoir is defined as an area between the at least one wall, the recess of the housing, and a surface of the sheet, and wherein the sheet is optically transparent. In some examples, the port is a first port, and wherein the reservoir is a first reservoir is a first reservoir, and wherein the wall is a first wall, and wherein the housing further comprises a second port, and wherein the gasket comprises a second wall defining a second reservoir, wherein the second reservoir is in fluid communication with the second port.

In some example embodiments, method 700 further involves fastening the housing with the sheet via a fastener. In some examples, the fastener comprises one or more datum pads. Additionally, in some examples, the fastener further comprises one or more heat stakes.

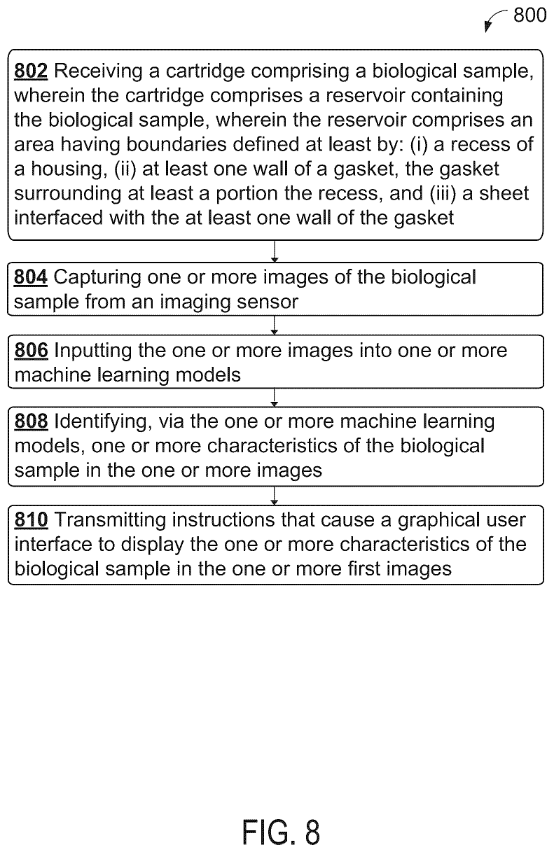

Now referring to FIG. 8, an example method of imaging a biological sample by an imaging device. Method 800 shown in FIG. 8 presents an example of a method of imaging a biological sample that could be used such as the example cartridges and/or imaging device shown in FIGS. 2A-4, for example. Further, devices or systems may be used or configured to perform logical functions presented in FIG. 8. In other examples, components of the devices and/or systems may be arranged to be adapted to, capable of, or suited for performing the functions, such as when operated in a specific manner. Method 800 may include one or more operations, functions, or actions as illustrated by one or more of blocks 802-810. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 802, method 800 involves receiving a cartridge comprising a biological sample, wherein the cartridge comprises a reservoir containing the biological sample, wherein the reservoir comprises an area having boundaries defined at least by: (i) a recess of a housing, (ii) at least one wall of a gasket, the gasket surrounding at least a portion of the recess, and (iii) a sheet interfaced with the at least one wall of the gasket. In some examples, the housing comprises a port, and wherein the port is in fluid communication with the reservoir.

At block 804, method 800 involves capturing one or more images of the biological sample from an imaging sensor.

At block 806, method 800 involves inputting the one or more images into one or more machine learning models.

At block 808, method 800 involves identifying, via the one or more machine learning models, one or more characteristics of the biological sample in the one or more images.

At block 810, method 800 involves transmitting instructions that cause a graphical user interface to display the one or more characteristics of the biological sample in the one or more images.

In some example implementations of method 800, the reservoir is a first reservoir comprising a first area, wherein the recess is a first recess, wherein the gasket comprises a second wall, and wherein the cartridge comprises a second reservoir having a second area having boundaries defined at least by: (i) a second recess of the housing, (ii) the second wall of the gasket, the second wall of the gasket surrounding at least a portion the second recess, and (iii) the sheet interfaced with the second wall of the gasket. In these examples, method 800 may involve capturing a second image of the second biological sample from the imaging sensor. Method 800 may additionally involve inputting the second image into the one or more machine learning models. Method 800 may further involve identifying, via the one or more machine learning models, one or more characteristics of the second biological sample in the second image. Method 800 may involve transmitting instructions that cause a graphical user interface to display the one or more characteristics of the second biological sample in the second image.

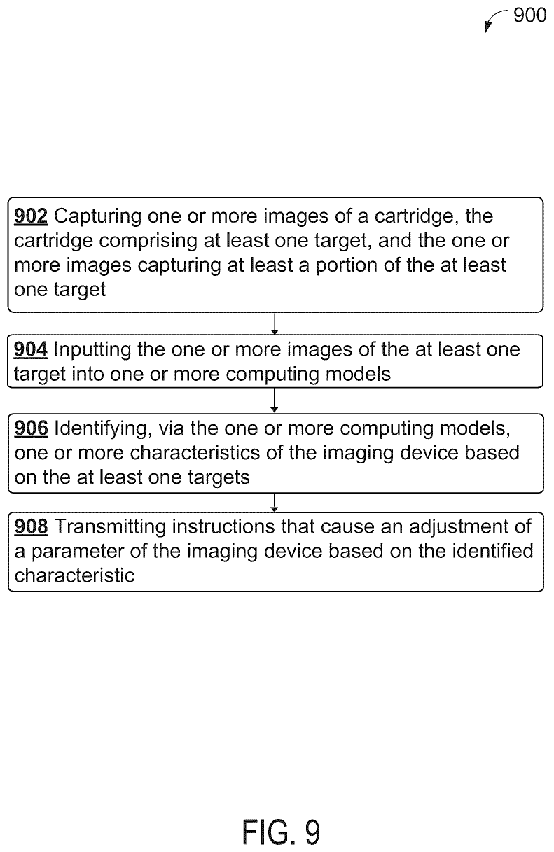

Now referring to FIG. 9, an example method of calibrating an imaging device. Method 900 shown in FIG. 9 presents an example of a method of calibrating an imaging device that could be used such as the example cartridges and/or imaging device shown in FIGS. 4-5, for example. Further, devices or systems may be used or configured to perform logical functions presented in FIG. 9. In other examples, components of the devices and/or systems may be arranged to be adapted to, capable of, or suited for performing the functions, such as when operated in a specific manner. Method 900 may include one or more operations, functions, or actions as illustrated by one or more of blocks 902-908. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 902, method 900 involves capturing one or more images of a cartridge, the cartridge comprising at least one target, and the one or more images capturing at least a portion of the at least one target. In some examples, the at least one target comprises an array of one or more targets.

At block 904, method 900 involves inputting the one or more images of the at least one target into one or more computing models.

At block 906, method 900 involves identifying, via the one or more computing models, one or more characteristics of the imaging device based on the targets.

At block 908, method 900 involves transmitting instructions that cause an adjustment of a parameter of the imaging device based on the identified characteristic. In some examples, the parameter comprises one or more of the following: resolution, optimal focus position, color offset, depth of field, tilt, modulation transfer function, color Z offset, distortion, field of view, magnification, illumination, and Z-parallelism to optics axis.

The singular forms of the articles “a,” “an,” and “the” include plural references unless the context clearly indicates otherwise. For example, the term “a compound” or “at least one compound” can include a plurality of compounds, including mixtures thereof.

Various aspects and embodiments have been disclosed herein, but other aspects and embodiments will certainly be apparent to those skilled in the art. Additionally, the various aspects and embodiments disclosed herein are provided for explanatory purposes and are not intended to be limiting, with the true scope being indicated by the following claims.

1. A cartridge for imaging a biological sample comprising:
a housing comprising: (i) a port and (ii) a recess for receiving the biological sample;
a gasket surrounding at least a portion of the recess of the housing, wherein the gasket comprises at least one wall defining a boundary of a reservoir, wherein the reservoir comprises the recess, and wherein the reservoir is in fluid communication with the port; and
a sheet interfaced with the at least one wall of the gasket, wherein when the at least one wall is interfaced with the sheet, the reservoir is defined as an area between the at least one wall, the recess of the housing, and a surface of the sheet, and wherein the sheet is optically transparent.

2. The cartridge of claim 1, wherein the housing comprises a fastener configured to interface the housing with the sheet.

3. The cartridge of claim 2, wherein the fastener comprises one or more datum pads.

4. The cartridge of claim 3, wherein the fastener further comprises one or more heat stakes.

5. The cartridge of claim 1, wherein the housing further comprises a channel, and wherein the gasket is disposed along the channel.

6. The cartridge of claim 1, wherein the housing is optically transparent.

7. The cartridge of claim 1, wherein the housing comprises a marking area.

8. The cartridge of claim 1, wherein the gasket comprises a compressible material.

9. The cartridge of claim 1, wherein the cartridge comprises a machine-readable identifier.

10. The cartridge of claim 1, wherein the port is a first port, and wherein the reservoir is a first reservoir is a first reservoir, and wherein the wall is a first wall, and wherein the housing further comprises a second port, and wherein the gasket comprises a second wall defining a second reservoir, wherein the second reservoir is in fluid communication with the second port.

11. The cartridge of claim 10, wherein when the sheet is interfaced with first and second wall of the gasket, the first reservoir is defined as a first area between the first wall, the recess of the housing, and a first surface of the sheet, and the second reservoir is defined as a second area between the second wall, the recess of the housing, and a second surface of the sheet.

12. The cartridge of claim 11, wherein a height of the first reservoir is greater than a height of the second reservoir.

13. The cartridge of claim 1, wherein the biological sample comprises one or more of the following: (i) blood; (ii) urine; (iii) saliva; (iv) fecal matter; (v) secretion; (vi) excretion; (vii) FNA; (viii) lavage fluids; (ix) body cavity fluids; (x) semen; (xi) ear wax; (xii) skin cells; (xiii) biopsied samples, (xiv) exotics; (xv) cultured cells; (xvi) bacteria; (xvii) worms; (xviii) parasites; and (xix) ear mites.

14. (canceled)

15. A method of manufacturing a cartridge for imaging, the method comprising:
fabricating a housing comprising (i) a port and (ii) a recess for receiving a biological sample;
surrounding the recess with a gasket, wherein the gasket comprises at least one wall defining a boundary of a reservoir, wherein the reservoir comprises the recess, and wherein the reservoir is in fluid communication with the port; and
disposing a sheet onto the at least one wall of the gasket, wherein when the at least one wall is interfaced with the sheet, the reservoir is defined as an area between the at least one wall, the recess of the housing, and a surface of the sheet, and wherein the sheet is optically transparent.

16. The method of claim 15, comprising:
fastening the housing with the sheet via a fastener.

17. The method of claim 16, wherein the fastener comprises one or more datum pads.

18. The method of claim 16, wherein the fastener further comprises one or more heat stakes.

19. The method of claim 15, wherein surrounding the recess with the gasket comprises disposing the gasket into a channel of the housing.

20. (canceled)

21. The method of claim 15, wherein the port is a first port, and wherein the reservoir is a first reservoir, and wherein the wall is a first wall, and wherein the housing further comprises a second port, and wherein the gasket comprises a second wall defining a second reservoir, wherein the second reservoir is in fluid communication with the second port.

22. A method for imaging a biological sample by an imaging device, the method comprising:
receiving a cartridge comprising a biological sample, wherein the cartridge comprises a reservoir containing the biological sample, wherein the reservoir comprises an area having boundaries defined at least by: (i) a recess of a housing, (ii) at least one wall of a gasket, the gasket surrounding at least a portion of the recess, and (iii) a sheet interfaced with the at least one wall of the gasket;
capturing one or more images of the biological sample from an imaging sensor;
inputting the one or more images into one or more machine learning models;
identifying, via the one or more machine learning models, one or more characteristics of the biological sample in the one or more images; and
transmitting instructions that cause a graphical user interface to display the one or more characteristics of the biological sample in the one or more images.

23.-28. (canceled)
